(19) United States
(12) Patent Application Publication
(10) Pub. No.: US 2010/0126339 A1
(43) Pub. Date: May 27, 2010

(54) ACTUATOR CONTROL DEVICE

(75) Inventor: Hiroshi Kobata, Kanagawa (JP)

Correspondence Address: RABIN & Berdo, PC, 1101 14TH STREET, NW, SUITE 500, WASHINGTON, DC, 20005, US

(73) Assignee: KAYABA INDUSTRY CO., LTD, TOKYO (JP)

(21) Appl. No.: 12/450,553

(22) PCT Filed: Apr. 9, 2008
(86) PCT No.: PCT/JP2008/057383

§ 371 Date: Sep. 30, 2009

(51) Int. Cl. F15B 11/02; F15B 11/028

(52) U.S. Cl. 91/444; 91/459

(57) ABSTRACT

An actuator control device includes a meter-in solenoid valve (V1) and a meter-out solenoid valve (V2) that control the supply and discharge of a working fluid relative to an anti rod-side oil chamber (4a), a meter-in solenoid valve (V3) and a meter-out solenoid valve (V4) that control the supply and discharge of the working fluid relative to a rod-side oil chamber (4b), a plurality of maps defining characteristics of opening areas of the meter-in solenoid valves (V1, V3) and the meter-out solenoid valves (V2, V4) relative to an actuator speed command, and a controller programmed to determine an operating condition of the actuator on the basis of a detection result from a detector that detects operation information relating to the actuator, and select a map to be used in control from the plurality of maps in accordance with the operating condition of the actuator.

### TECHNICAL FIELD

This invention relates to an actuator control device, and more particularly to a control device for controlling an actuator that drives a movable member of a construction machine.

### BACKGROUND ART

A conventional actuator installed in a construction machine includes a control valve interposed between the actuator and a hydraulic pump, and a spool of the control valve is mechanically connected to an operating lever operated by an operator (see JP11-107328A).

The operator drives the actuator by operating the operating lever to switch the position of the control valve, thereby regulating the supply and discharge of a working oil to and from the actuator.

In a control valve provided in this type of actuator, the characteristics of meter-in and meter-out opening areas relative to a lever operating amount are univocally determined (see FIG. 3 of JP11-107328A).

### DISCLOSURE OF THE INVENTION

When the characteristics of the meter-in and meter-out opening areas relative to the lever operating amount are univocally determined in this manner, the characteristics of the meter-in and meter-out opening areas may not be optimal, depending on operating conditions such as the load and speed of the actuator. In this case, a situation in which the actuator does not operate smoothly may occur.

This invention has been designed in consideration of the problem described above, and it is an object thereof to provide an actuator control device with which the actuator can be operated smoothly, regardless of the operating conditions of the actuator.

This invention is an actuator control device for controlling an actuator that drives a movable member of a construction machine. The actuator control device comprises the actuator, which is driven by a working fluid supplied from a pump, a first meter-in solenoid valve and a first meter-out solenoid valve which respectively control the working fluid supplied to the actuator and the working fluid discharged from the actuator to drive the actuator in one direction, a second meter-in solenoid valve and a second meter-out solenoid valve which respectively control the working fluid supplied to the actuator and the working fluid discharged from the actuator to drive the actuator in the other direction, a plurality of maps defining characteristics of opening areas of the meter-in solenoid valves and the meter-out solenoid valves relative to a speed command relating to the actuator, and a controller programmed to determine an operating condition of the actuator on the basis of a detection result from a detector that detects operation information relating to the actuator; and select a map to be used in control from the plurality of maps in accordance with the operating condition of the actuator determined.

According to this invention, supply and discharge of the working fluid used to drive the actuator in one direction and the other direction is controlled by four independent solenoid valves, and a plurality of maps defining characteristics of the opening areas of the meter-in solenoid valves and the meter-out solenoid valves relative to the speed command relating to the actuator are provided. The map to be used in the control is selected from the plurality of maps in accordance with the operating condition of the actuator, and therefore the actuator can be operated smoothly regardless of operating conditions such as the load and speed of the actuator.

### BRIEF DESCRIPTION OF THE DRAWINGS

FIG. 1 is a hydraulic circuit diagram of an actuator control device according to an embodiment of this invention.

FIG. 2 is a map defining opening area characteristics of a meter-in solenoid valve and a meter-out solenoid valve relative to an actuator speed command.

FIG. 3A is a hydraulic circuit diagram of an actuator control device according to a second embodiment of this invention.

FIG. 3B is a map defining opening area characteristics of a meter-in solenoid valve and a meter-out solenoid valve relative to an actuator speed command.

FIGS. 4A and 4B are views illustrating control executed during activation of the actuator by an actuator control device according to a third embodiment of this invention.

FIG. 5 is a map defining opening area characteristics of a meter-in solenoid valve and a meter-out solenoid valve relative to an actuator speed command.

FIGS. 6A to 6C are views illustrating control executed during stoppage of the actuator by the actuator control device according to the third embodiment of this invention.

### BEST MODES FOR CARRYING OUT THE INVENTION

Referring to the figures, an actuator control device according to an embodiment of this invention will be described below.

The actuator control device according to this embodiment controls an operation of an actuator that drives a movable member installed in a construction machine.

The actuator according to this embodiment is constituted by a hydraulic motor and a hydraulic cylinder. When the construction machine is a hydraulic shovel, the hydraulic motor is a revolving hydraulic motor that causes an upper portion revolving body to revolve and a travel hydraulic motor that causes the construction machine to travel. Further, the hydraulic cylinder is a hydraulic cylinder that drives a boom connected rotatably to the upper portion revolving body, an arm connected rotatably to a tip end of the boom, and a bucket connected rotatably to a tip end of the arm.

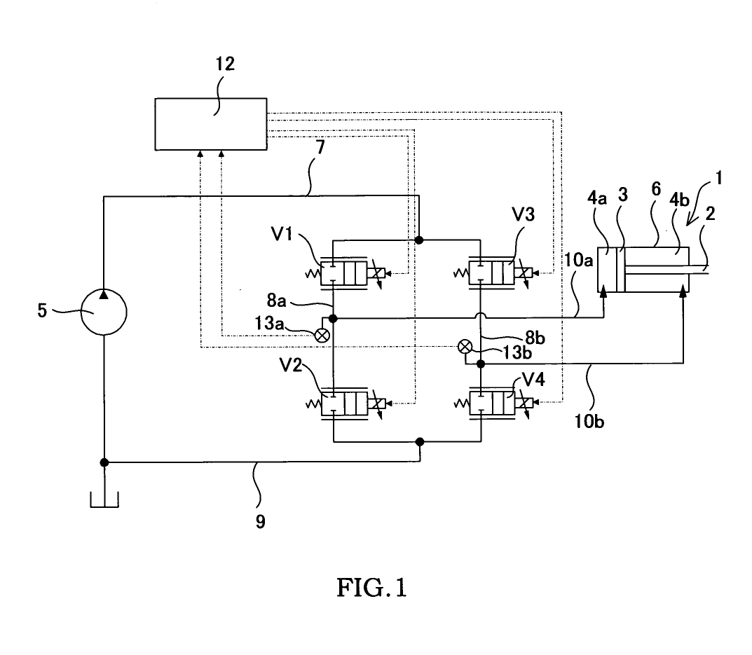

First, referring to FIG. 1, a hydraulic circuit which is common to actuator control devices according to first to third embodiments, to be described below, will be described. It should be noted that FIG. 1 illustrates a case in which the actuator is a hydraulic cylinder 1 driven by working oil (working fluid).

The hydraulic cylinder 1 includes a cylinder tube 6 in which working oil is sealed, a piston 3 that divides the interior of the cylinder tube 6 into an anti rod-side oil chamber 4a and a rod-side oil chamber 4b and moves through the interior of the cylinder tube 6 in a sliding motion, and a rod 2, one end of which is joined to the piston 3 and the other end of which projects from the cylinder tube 6.

The hydraulic cylinder 1 is driven by working oil supplied from a hydraulic pump 5.

A supply passage 7 carrying working oil to be supplied to the hydraulic cylinder 1 is connected to a discharge side of the hydraulic pump 5, and the supply passage 7 is connected to branch passages 8a, 8b bifurcating in two directions. The branch passages 8a, 8b then re-converge so as to join a discharge passage 9 carrying working oil discharged from the hydraulic cylinder 1. The discharge passage 9 is connected to a suction side of the hydraulic pump 5.

A meter-in solenoid valve V1 (first meter-in solenoid valve) for controlling the flow of the working oil supplied to the anti rod-side oil chamber 4a of the hydraulic cylinder 1 and a meter-in solenoid valve V3 (second meter-in solenoid valve) for controlling the flow of the working oil supplied to the rod-side oil chamber 4b are interposed in parallel in the branch passages 8a, 8b.

Further, a meter-out solenoid valve V2 (second meter-out solenoid valve) for controlling the flow of the working oil discharged from the anti rod-side oil chamber 4a of the hydraulic cylinder 1 and a meter-out solenoid valve V4 (first meter-out solenoid valve) for controlling the flow of the working oil discharged from the rod-side oil chamber 4b are interposed in parallel in the branch passages 8a, 8b.

Hence, the meter-in solenoid valve V1 and the meter-out solenoid valve V2 are interposed in series in the branch passage 8a, while the meter-in solenoid valve V3 and the meter-out solenoid valve V4 are interposed in series in the branch passage 8b.

A first supply/discharge passage 10a that communicates with the anti rod-side oil chamber 4a is connected between the meter-in solenoid valve V1 and the meter-out solenoid valve V2 in the branch passage 8a. And a second supply/discharge passage 10b that communicates with the rod-side oil chamber 4b is connected between the meter-in solenoid valve V3 and the meter-out solenoid valve V4 in the branch passage 8b.

The meter-in solenoid valve V1, meter-out solenoid valve V2, meter-in solenoid valve V3, and meter-out solenoid valve V4 are solenoid control valves (flow control valves). Each solenoid valve V1 to V4 is driven by a control current output from a controller 12 such that an opening area thereof is adjusted in accordance with the control current. Hence, the controller 12 adjusts the opening areas of the respective solenoid valves V1 to V4 individually such that the flow of the working oil passing through the respective solenoid valves V1 to V4 is controlled individually.

Further, the solenoid valves V1 to V4 are provided integrally with or provided in the vicinity of the hydraulic cylinder 1. Hence, in the construction machine according to this invention, the control valves (the solenoid valves V1 to V4) that control operations of the actuator are discretely disposed control valves which are provided integrally with or provided in the vicinity of the respective actuators.

By disposing the solenoid valves V1 to V4 discretely together with the respective actuators, the length of the pipes (the first supply/discharge passage 10a and second supply/discharge passage 10b in FIG. 1) connecting the solenoid valves V1 to V4 to the actuators can be reduced, leading to a reduction in the frequency of problems such as oil leakage.

The controller 12 includes a CPU that controls processing operations of the entire control device, a ROM storing programs, maps, and so on required in the processing operations of the CPU, a RAM that temporarily stores data read from the ROM, data read by various measuring instruments, and so on.

An operation of the hydraulic circuit shown in FIG. 1 will be described.

When the hydraulic cylinder 1 is caused to expand, the meter-in solenoid valve V1 and the meter-out solenoid valve V4 are opened while the meter-in solenoid valve V3 and the meter-out solenoid valve V2 are closed. As a result, the working oil that is discharged from the hydraulic pump 5 flows into the anti rod-side oil chamber 4a through the supply passage 7, the branch passage 8a, the meter-in solenoid valve V1, and the first supply/discharge passage 10a, and the working oil that is discharged from the rod-side oil chamber 4b flows into the suction side of the hydraulic pump 5 through the second supply/discharge passage 10b, the meter-out solenoid valve V4, the branch passage 8b, and the discharge passage 9.

On the other hand, when the hydraulic cylinder 1 is caused to contract, the meter-in solenoid valve V3 and the meter-out solenoid valve V2 are opened while the meter-in solenoid valve V1 and the meter-out solenoid valve V4 are closed. As a result, the working oil that is discharged from the hydraulic pump 5 flows into the rod-side oil chamber 4b through the supply passage 7, the branch passage 8b, the meter-in solenoid valve V3, and the second supply/discharge passage 10b, and the working oil that is discharged from the anti rod-side oil chamber 4a flows into the suction side of the hydraulic pump 5 through the first supply/discharge passage 10a, the meter-out solenoid valve V2, the branch passage 8a, and the discharge passage 9.

Hence, the meter-in solenoid valve V1 and the meter-out solenoid valve V4 are solenoid valves for driving the hydraulic cylinder 1 in a direction that causes the rod 2 to advance, or in other words for causing the hydraulic cylinder 1 to expand, while the meter-in solenoid valve V3 and the meter-out solenoid valve V2 are solenoid valves for driving the hydraulic cylinder 1 in a direction that causes the rod 2 to retreat, or in other words for causing the hydraulic cylinder 1 to contract.

### FIRST EMBODIMENT

An actuator control device according to a first embodiment of this invention will now be described.

As described above, operations of the hydraulic cylinder 1 are controlled by four independent solenoid valves. More specifically, a supply flow and a discharge flow of the working oil during an expansion operation of the hydraulic cylinder 1 are controlled individually by the meter-in solenoid valve V1 and the meter-out solenoid valve V4, while the supply flow and discharge flow of the working oil during a contraction operation of the hydraulic cylinder 1 are controlled individually by the meter-in solenoid valve V3 and the meter-out solenoid valve V2.

Hence, by controlling the operations of the respective solenoid valves V1 to V4 individually, the flow of the working oil passing through the solenoid valves V1 to V4 can be controlled individually. In other words, meter-in control and meter-out control can be set freely in accordance with the operating conditions of the hydraulic cylinder 1.

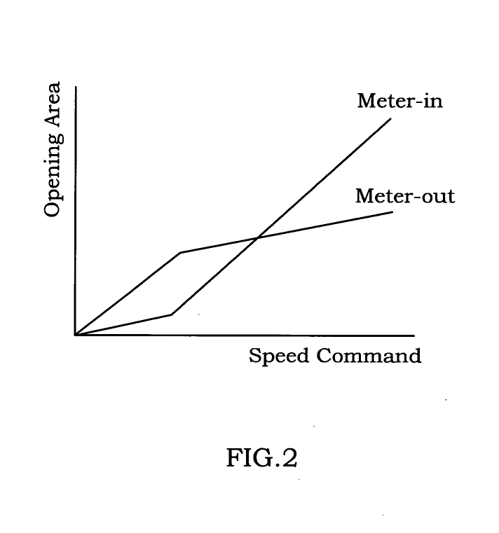

A plurality of maps defining characteristics of opening areas of the meter-in solenoid valves V1, V3 and opening areas of the meter-out solenoid valves V2, V4 relative to a speed command relating to the hydraulic cylinder 1, such as that shown in FIG. 2, are stored in the ROM of the controller 12. The plurality of maps are set with respectively different characteristics.

On the basis of detection results from detectors provided on the hydraulic cylinder 1 to detect various operation information relating to the hydraulic cylinder 1, the controller 12 determines the operating conditions of the hydraulic cylinder 1 (determining means). And in accordance with the operating conditions, the controller 12 selects an optimum map to be used in control from the plurality of maps stored in the ROM (selecting means). The detectors are constituted, for example, by pressure gauges 13a, 13b (pressure detectors) shown in FIG. 1, which detect the respective pressures in the anti rod-side oil chamber 4a and the rod-side oil chamber 4b of the hydraulic cylinder 1, a speedometer (not shown) that detects the speed of the hydraulic cylinder 1, and so on, and on the basis of detection results from the detectors, operating conditions such as the load and speed of the hydraulic cylinder 1 are determined.

Hence, the controller 12 is programmed to set optimal meter-in and meter-out opening areas in accordance with the operating conditions of the hydraulic cylinder 1. In so doing, shock generated during an operation of the hydraulic cylinder 1 can be prevented, and the hydraulic cylinder 1 can be operated smoothly.

The reason why the meter-in and meter-out opening areas can be set freely in accordance with the operating conditions of the hydraulic cylinder 1 is that working oil supply and discharge during the expansion and contraction operations of the hydraulic cylinder 1 can be controlled respectively by the four solenoid valves V1 to V4.

Meter-in control and meter-out control executed by the controller 12 using maps will now be described specifically.

First, the current operating conditions of the hydraulic cylinder 1 are determined on the basis of the detection results obtained from the respective detectors, whereupon an optimum map for use during the control is selected from the plurality of maps.

A current position of the operating lever operated by the operator of the construction machine is then detected by a position detector such as a potentiometer, whereupon a speed command relating to the hydraulic cylinder 1 and corresponding to the abscissa of the map is calculated on the basis of the detected current position of the operating lever.

Then, on the basis of the map selected in accordance with the operating conditions of the hydraulic cylinder 1, a target opening area corresponding to the calculated speed command is determined.

The respective valve openings of the solenoid valves V1 to V4 are then controlled to achieve the target opening area. More specifically, by supplying a control current corresponding to the calculated speed command to the solenoids of the solenoid valves V1 to V4, the solenoid valves V1 to V4 are controlled to the target opening area.

As regards the selected map, when the operating conditions of the hydraulic cylinder 1 indicate activation or stoppage, a map having a characteristic whereby the opening area of the meter-out solenoid valves V2, V4 is larger than the opening area of the meter-in solenoid valves V1, V3 in a small speed command region, for example, is selected, as shown in FIG. 2. In so doing, meter-out side pressure loss is reduced, enabling smooth activation and stoppage.

Further, in a large speed command region of the map shown in FIG. 2, the opening area of the meter-out solenoid valves V2, V4 is smaller than the opening area of the meter-in solenoid valves V1, V3. In other words, the small speed command region and the large speed command region have opposite characteristics.

Hence, by narrowing the opening area of the meter-out solenoid valves V2, V4 in the large speed command region, runaway is less likely to occur in the hydraulic cylinder 1 due to its own weight and inertia, making speed control easier.

The selected map is switched successively in accordance with the load, speed, and other operating conditions of the hydraulic cylinder 1 such that the opening areas of the respective solenoid valves V1 to V4 are controlled optimally in accordance with the operating conditions of the hydraulic cylinder 1.

Maps having different characteristics may be selected depending on whether the expansion operation or the contraction operation is underway in the hydraulic cylinder 1. More specifically, the opening area characteristics of the meter-in solenoid valve V1 and the meter-out solenoid valve V4, which are opened during the expansion operation of the hydraulic cylinder 1, may be set differently to the opening area characteristics of the meter-in solenoid valve V3 and the meter-out solenoid valve V2, which are opened during the contraction operation of the hydraulic cylinder 1.

According to the embodiment described above, the following effects are obtained.

In a conventional control valve in which the spool is mechanically connected to the operating lever operated by the operator, the characteristics of the meter-in and meter-out opening areas relative to the lever operating amount are univocally determined, and therefore the characteristics of the meter-in and meter-out opening areas cannot be modified.

According to this embodiment, however, working oil supply and discharge during the expansion operation and contraction operation of the hydraulic cylinder 1 can be respectively controlled by the four solenoid valves V1 to V4, and therefore the meter-in and meter-out opening areas can be modified freely. Hence, the meter-in and meter-out opening areas can be controlled optimally in accordance with the operating conditions of the hydraulic cylinder 1, and as a result, shock generated during an operation of the hydraulic cylinder 1 can be prevented such that the hydraulic cylinder 1 can be operated smoothly.

### SECOND EMBODIMENT

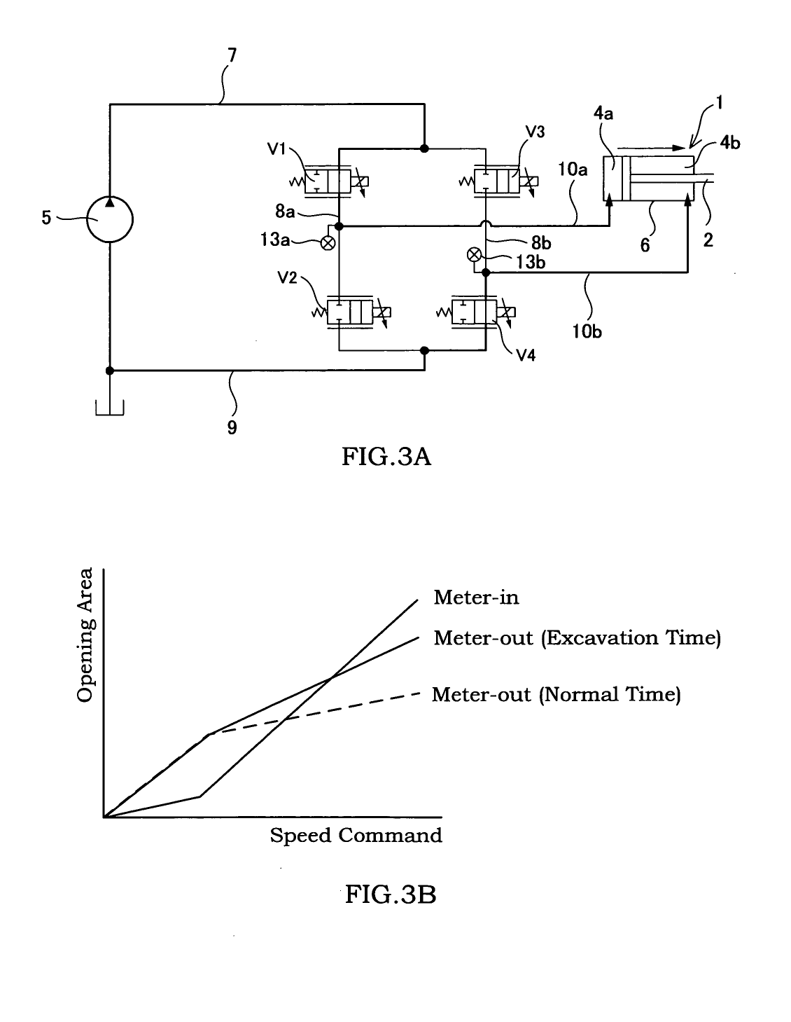

Next, referring to FIG. 3, an actuator control device according to a second embodiment of this invention will be described.

In this embodiment, the construction machine is a hydraulic shovel and the actuator is the hydraulic cylinder 1 for driving the boom, arm, and bucket.

As shown in FIG. 3A, when the hydraulic shovel performs an excavation operation, the meter-in solenoid valve V1 and the meter-out solenoid valve V4 open such that the respective hydraulic cylinders 1 that drive the boom, the arm, and the bucket perform an expansion operation. As a result, the pressure in the rod-side oil chamber 4b increases.

When excavation by the hydraulic shovel is not underway, the map on which the opening areas of the solenoid valves V1 to V4 are narrowed is selected from the maps shown in the first embodiment to prevent runaway in the hydraulic cylinder 1 when the hydraulic cylinder 1 is driven. If this map is used during excavation, pressure loss in the meter-out solenoid valve V4 increases, leading to wasteful loss during excavation.

When excavation by the hydraulic shovel is underway, there is no danger of runaway in the hydraulic cylinder 1, and therefore an increase in the opening area of the meter-out solenoid valve V4 is not problematic. Hence, by executing control to increase the opening area of the meter-out solenoid valve V4 during excavation, wasteful loss can be prevented.

Specific processing performed by the controller 12 will be described.

First, the pressure of the rod side oil chamber 4b is detected by the pressure gauge 13b and input into the controller 12.

On the basis of the detection result detected by the pressure gauge 13b, a load condition of the rod-side oil chamber 4b is determined. More specifically, when the pressure of the rod-side oil chamber 4b is greater than a preset reference value, the load of the hydraulic cylinder 1 is determined to be large, and accordingly, excavation is determined to be currently underway in the hydraulic cylinder 1.

When excavation is determined to be underway in the hydraulic cylinder 1, a map on which the opening area relative to the speed command increases beyond the current opening area is selected in relation to the meter-out solenoid valve V4. For example, as shown in FIG. 3B, a map setting the normal opening area of the meter-out solenoid valve V4, shown by a broken line, is switched to a map setting the opening area of the meter-out solenoid valve V4 during excavation, shown by a solid line. It should be noted that the map shown in FIG. 3B is merely an example, and as long as the opening area of the meter-out solenoid valve V4 increases beyond the current opening area, a map having any characteristics may be employed.

Hence, when excavation is determined to be underway in the hydraulic cylinder 1, control is executed to increase the opening area of the meter-out solenoid valve V4, leading to a reduction in meter-out side pressure loss, and as a result, wasteful loss can be prevented. Thus, the hydraulic cylinder 1 can be operated smoothly, and the excavation operation can be performed efficiently.

### THIRD EMBODIMENT

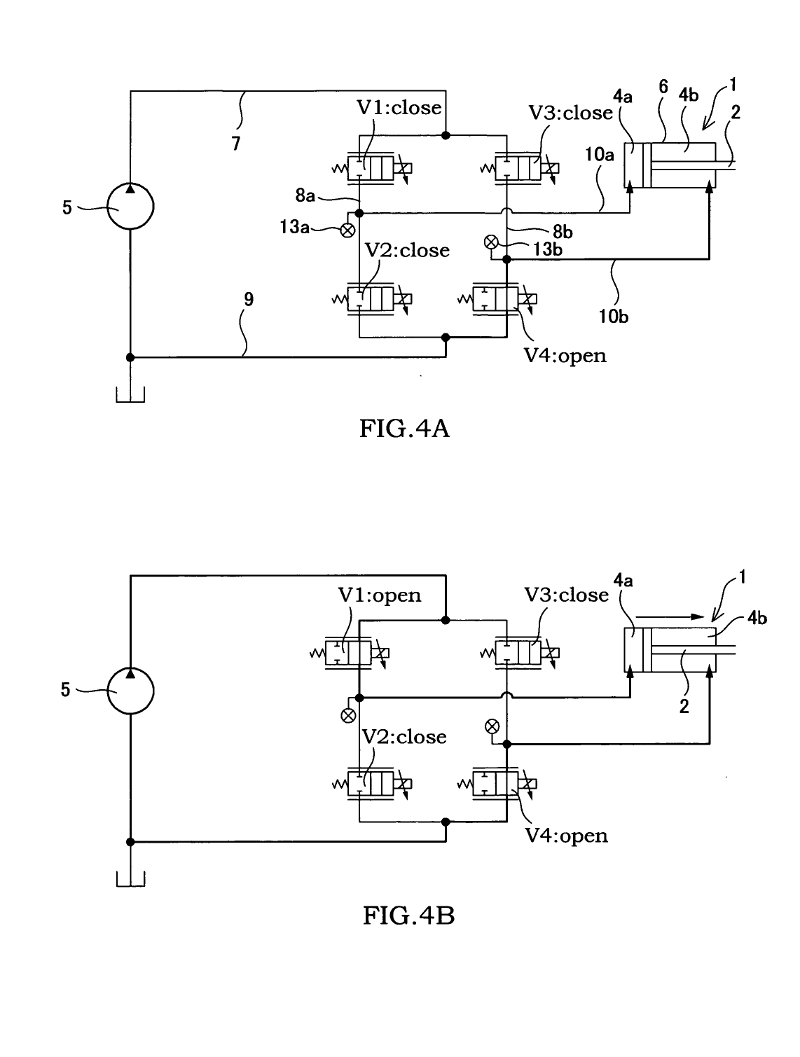

Next, referring to FIGS. 4 to 6, an actuator control device according to a third embodiment of this invention will be described. In this embodiment, a case in which the actuator is the hydraulic cylinder 1 will be described.

In addition to the control performed by the control device according to the first embodiment, the control device according to this embodiment controls opening/closing timings of the respective solenoid valves V1 to V4 during activation and stoppage of the hydraulic cylinder 1.

First, referring to FIG. 4, control performed during activation of the hydraulic cylinder 1 will be described. A case in which the hydraulic cylinder 1 is activated in an expansion direction will be described below.

To activate the hydraulic cylinder 1, first, as shown in FIG. 4A, the meter-out solenoid valve V4 is opened to open the rod-side oil chamber 4b from a state in which the respective solenoid valves V1 to V4 are closed.

Next, as shown in FIG. 4B, the meter-in solenoid valve V1 is opened to supply working oil to the anti rod-side oil chamber 4a, and as a result, the hydraulic cylinder 1 performs an expansion operation.

By performing control to open the meter-out solenoid valve V4 first and then open the meter-in solenoid valve V1 in this manner, high pressure is not generated in the rod-side oil chamber 4b in the advancement direction of the rod 2 during activation of the hydraulic cylinder 1, and therefore the hydraulic cylinder 1 is activated smoothly.

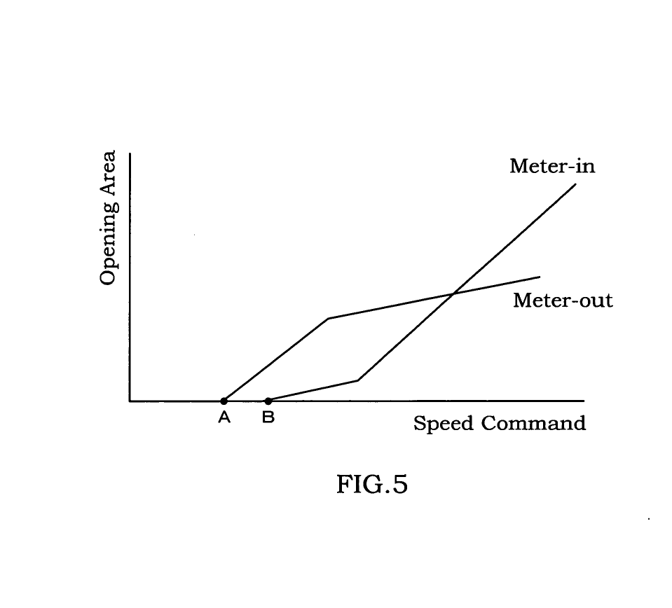

The timings at which the meter-out solenoid valve V4 and the meter-in solenoid valve V1 begin to open can be set freely in accordance with the load, speed, and other operating conditions of the hydraulic cylinder 1. More specifically, as shown in FIG. 5, the opening timings of the meter-out solenoid valve V4 and the meter-in solenoid valve V1 can be set by modifying the positions of a point A, which is the timing at which the meter-out solenoid valve V4 begins to open, and a point B, which is the timing at which the meter-in solenoid valve V1 begins to open, on the abscissa (speed command) of the map shown in the first embodiment.

It should be noted that when the hydraulic cylinder 1 is activated in a contraction direction, control is performed to open the meter-out solenoid valve V2 first and then open the meter-in solenoid valve V3.

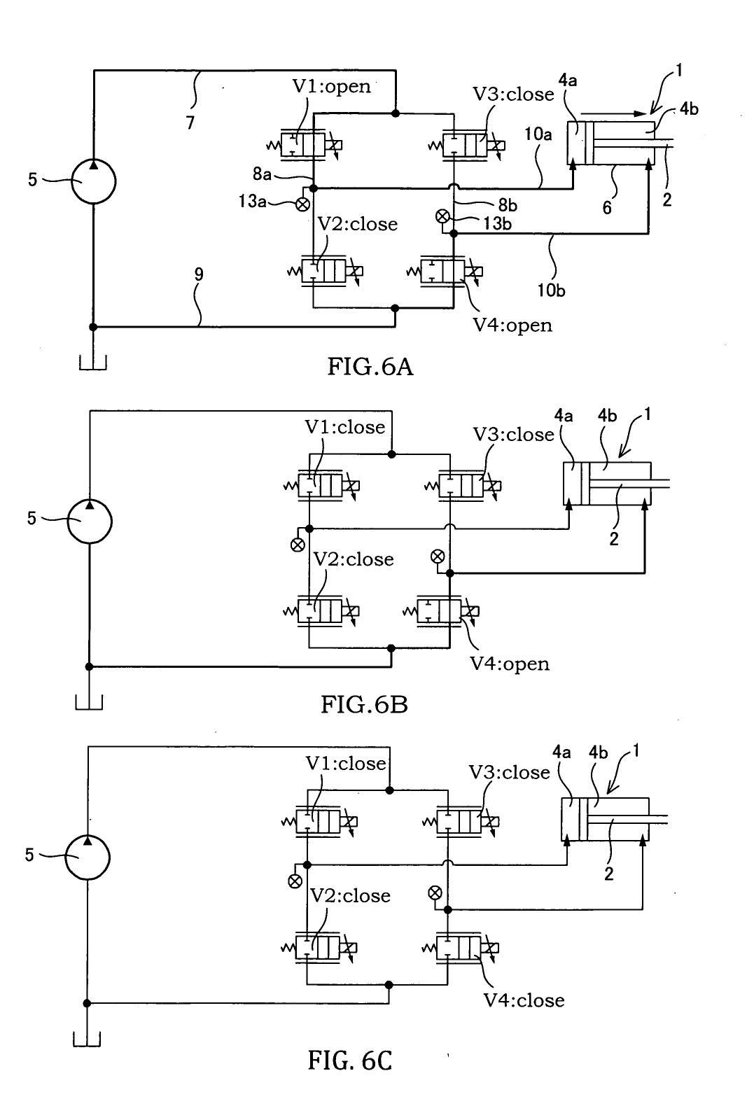

Next, referring to FIG. 6, control executed during stoppage of the hydraulic cylinder 1 will be described. A case in which the hydraulic cylinder 1 is stopped while operating in the expansion direction will be described below.

When the hydraulic cylinder 1 operates in the expansion direction, the meter-in solenoid valve V1 and the meter-out solenoid valve V4 are open, as shown in FIG. 6A.

To stop the hydraulic cylinder 1 from this state, first, as shown in FIG. 6B, the meter-in solenoid valve V1 is closed to halt the supply of working oil to the anti rod-side oil chamber 4a.

By closing the meter-in solenoid valve V1, the working oil supply to the anti rod-side oil chamber 4a is halted, but inertia causes the hydraulic cylinder 1 to attempt to expand. However, the meter-out solenoid valve V4 is open, and therefore high pressure is not generated in the rod-side oil chamber 4b.

Once the expansion speed of the hydraulic cylinder 1 generated by inertial force has decreased sufficiently, the meter-out solenoid valve V4 is closed, as shown in FIG. 6C.

By performing control to close the meter-in solenoid valve V1 first and then close the meter-out solenoid valve V4 in this manner, high pressure is not generated in the rod-side oil chamber 4b in the advancement direction of the rod 2 during stoppage of the hydraulic cylinder 1, and therefore the hydraulic cylinder 1 is stopped smoothly.

The timings at which the meter-in solenoid valve V1 and the meter-out solenoid valve V4 close can be set freely in accordance with the load, speed, and other operating conditions of the hydraulic cylinder 1. More specifically, as shown in FIG. 5, the closing timings of the meter-in solenoid valve V1 and the meter-out solenoid valve V4 can be set by modifying the positions of the point B, which is the timing at which the meter-in solenoid valve V1 closes, and the point A, which is the timing at which the meter-out solenoid valve V4 closes, on the abscissa (speed command), similarly to the activation operation described above.

It should be noted that when the hydraulic cylinder 1 is stopped while operating in the contraction direction, control is performed to close the meter-in solenoid valve V3 first and then close the meter-out solenoid valve V2.

According to this embodiment, working oil supply and discharge during the expansion operation and contraction operation of the hydraulic cylinder 1 can be controlled by the four solenoid valves V1 to V4, and therefore the meter-in and meter-out opening timings during activation of the hydraulic cylinder 1 and the meter-in and meter-out closing timings during stoppage of the hydraulic cylinder 1 can all be controlled freely. Hence, the opening/closing timings of the solenoid valves V1 to V4 during activation and stoppage of the hydraulic cylinder 1 can be controlled optimally in accordance with the condition of the hydraulic cylinder 1, enabling smooth activation and stoppage of the hydraulic cylinder 1.

This invention is not limited to the embodiments described above, and may be subjected to various modifications within the scope of the technical spirit thereof.

### INDUSTRIAL APPLICABILITY

This invention may be applied to a control device for controlling an actuator that drives a movable member of a construction machine.

1. An actuator control device for controlling an actuator that drives a movable member of a construction machine, comprising:
the actuator, which is driven by a working fluid supplied from a pump;
a first meter-in solenoid valve and a first meter-out solenoid valve which respectively control the working fluid supplied to the actuator and the working fluid discharged from the actuator to drive the actuator in one direction;
a second meter-in solenoid valve and a second meter-out solenoid valve which respectively control the working fluid supplied to the actuator and the working fluid discharged from the actuator to drive the actuator in the other direction;
a plurality of maps defining characteristics of opening areas of the meter-in solenoid valves and the meter-out solenoid valves relative to a speed command relating to the actuator; and
a controller programmed to:
determine an operating condition of the actuator on the basis of a detection result from a detector that detects operation information relating to the actuator; and
select a map to be used in control from the plurality of maps in accordance with the operating condition of the actuator determined.

2. The actuator control device as defined in claim 1, wherein the actuator is a hydraulic cylinder comprising an anti rod-side oil chamber and a rod-side oil chamber in which the working fluid is sealed,
the first meter-in solenoid valve and the first meter-out solenoid valve control an expansion operation of the actuator,
the second meter-in solenoid valve and the second meter-out solenoid valve control a contraction operation of the actuator,
a pressure detector that detects a pressure of the rod-side oil chamber is provided,
the controller is programmed to:
determine that a load of the rod-side oil chamber is large when the pressure of the rod-side oil chamber is greater than a preset reference value, and
select a map on which an opening area of the first meter-out solenoid valve relative to the speed command relating to the actuator increases beyond a current opening area when the load of the rod-side oil chamber is determined to be large.

3. The actuator control device as defined in claim 1, wherein, during activation of the actuator, the meter-out solenoid valves are opened first, whereupon the meter-in solenoid valves are opened.

4. The actuator control device as defined in claim 1, wherein, during stoppage of the actuator, the meter-in solenoid valves are closed first, whereupon the meter-out solenoid valves are closed.
